(19) United States
(12) Patent Application Publication
(10) Pub. No.: US 2018/0307189 A1
(43) Pub. Date: Oct. 25, 2018

(54) OPERATION CONTROL MODEL GENERATOR, OPERATION CONTROL MODEL GENERATION METHOD, AND NON-TRANSITORY COMPUTER READABLE MEDIUM STORING PROGRAM

(71) Applicant: NEC CORPORATION, Tokyo (JP)

(72) Inventors: Alexander VIEHWEIDER, Tokyo (JP); Takuma KOGO, Tokyo (JP); Takahiro TOIZUMI, Tokyo (JP)

(73) Assignee: NEC CORPORATION, Tokyo (JP)

(21) Appl. No.: 15/770,907

(22) PCT Filed: Oct. 29, 2015
(86) PCT No.: PCT/JP2015/005456

§ 371 Date: Apr. 25, 2018

(51) Int. Cl. G05B 15/02; G06F 17/50

(52) U.S. Cl. CPC G05B 15/02; G06F 17/50

(57) ABSTRACT

An operation control model generator (100) includes a generator core (101) and an automatic modeling unit (102). The generator core (100) is configured to read metadata representing a configuration of a building to acquire primitives of the building from a building information model, read basic models corresponding to the acquired primitives from a basic operation control model database (140), and send out the acquired basic models. The automatic modeling unit (102) is configured to receive the acquired basic models from the generator core (101), adjust the acquired basic models based on one or both of a resent measurement dataset (120) and an operation history generator (130), and convert the basic models into an operation control model.

### TECHNICAL FIELD

The present invention relates to an operation control model generator, an operation control model generation method, and a non-transitory computer readable medium storing a program.

### BACKGROUND ART

A building management system (also as referred to as a BMS) and a building energy management system (also as referred to as a BEMS) can achieve high efficient and comfortable use of a building. However, complex tasks are required to configure and adapt the BMS and BEMS, so that those tasks are time-intensive and cost-intensive. The more functionality the BMS and BEMS include, the more complex the building and its use are, the more efforts for installing, configuring and adapting the BMS and BEMS are necessary.

In this case, the BMS and/or BEMS may be manually or semi-automatically configured (e.g., HVAC (Heating, Ventilating, and Air Conditioning) equipment). Recently, a building information model (also as referred to BIM) has been emerged as a structured way to approach a planning process and a building process of the building. The BIM is an intelligent model-based process that provides insight to help to plan, design, construct, and manage buildings and infrastructure. The BIM may include information of building shapes, spatial relations (topology), a site location, materials (e.g., a material plan, a light equipment plan, a HVAC (Heating, Ventilating, and Air Conditioning) plan, a structural blueprint, an architectural plan, an electric wiring plan, et cetera.), et cetera. In the case of using the BIM, the building can have multi views (databases), and further intra-consistency of each dataset thereof and inter-consistency among datasets thereof are automatically guaranteed.

For example, NPL1 discloses an energy management system that is based on the BIM. Further, control methods for HVAC system are disclosed in PTL1 and NPL2.

### CITATION LIST

### Patent Literature

PTL 1: US89150510A

### Non Patent Literature

NPL 1: P. Stenzel, J. Haufe, N. Jimenez-Redondo, “Using a Multi-Model for a BIM-based Design and Operation of Building Energy Management Systems”, eWork and eBusiness in Architecture, Engineering and Construction, ECPPM 2014, CRC Press 2014, Chapter 109, Pages 813-820
NPL 2: Xuesong Liu, Burcu Akinci, Mario Berges, James H. Garrett, Jr, “An integrated performance analysis framework for HVAC systems using heterogeneous data models and building automation systems”, Proceedings of the Fourth ACM Workshop on Embedded Sensing Systems for Energy-Efficiency in Buildings, 2012, Pages 145-152

### SUMMARY OF INVENTION

### Technical Problem

However, the inventers have found a problem in the general BIM as described below. In general, the building needs to be appropriately controlled to achieve a comfortable condition (e.g., temperature, humidity, air conditioning, et cetera.) or cost-effective operation. Thus, an operation control model (also referred to as an OCM) for controlling the building condition is needed. However, PTL1 mentions only the energy calculator and does not disclose how to acquire the OCM. Therefore, a detailed methodology for generating the OCM has been desired to make it possible to automatically configuring the BMS and/or BEMS.

The present invention has been made in view of the above-mentioned problem, and an object of the present invention is to provide a building operation control model generator capable of automatically generating the operation control model (OCM) for a building.

### Solution to Problem

An aspect of the present invention is an operation control model generator including: a generator core configured to read metadata representing a configuration of a building to acquire primitives of the building from a building information model, read basic models corresponding to the acquired primitives from a basic operation control model database, and send out the acquired basic models; and a modelling unit configured to receive the acquired basic models from the generator core, adjust the acquired basic models based on building condition information, and convert the basic models into an operation control model.

An aspect of the present invention is an operation control model generation method of a building including: reading metadata representing a configuration of a building to acquire primitives of the building from a building information model, reading basic models corresponding to the acquired primitives from a basic operation control model database, and sending out the acquired basic models; and receiving the acquired basic models, adjusting the acquired basic models based on building condition information, and converting the basic models into an operation control model.

An aspect of the present invention is a non-transitory computer readable medium storing an operation control model generation program for causing a computer to execute processing including: causing an operation core to read metadata representing a configuration of a building to acquire primitives of the building from a building information model from a storage, to read basic models corresponding to the acquired primitives from a basic operation control model database from the storage, and to send out the acquired basic models; and causing an modeling unit to receive the acquired basic models, to adjust the acquired basic models based on building condition information, and to convert the basic models into an operation control model.

### Advantageous Effects of Invention

According to the present invention, it is possible to provide a building operation control model generator capable of automatically generating an operation control model (OCM) for a building.

### BRIEF DESCRIPTION OF DRAWINGS

FIG. 1 is a block diagram schematically illustrating a configuration of a building control system including an operation control model (OCM) generator according to a first embodiment.

FIG. 2 is a block diagram schematically illustrating a configuration of the BIM (Building information model).

FIG. 3 is a block diagram schematically illustrating basic models included in a basic OCM database.

FIG. 4 is a block diagram schematically illustrating a configuration of an OCM generator.

FIG. 5 is a block diagram schematically illustrating a detailed configuration of the building control system.

FIG. 6 is a block diagram schematically illustrating a configuration of an automatic modeling unit 102.

FIG. 7 is a diagram illustrating a configuration of a BIM of a particular example.

FIG. 8 is a diagram illustrating a particular configuration of the basic topology OCM block of the particular example.

FIG. 9 is a diagram illustrating a configuration of a part of the overall topology information.

FIG. 10 is a diagram illustrating the particular example of the equipment structure primitive.

FIG. 11 is a diagram illustrating a particular example of the configuration of the acquired basic OCM model of the structure.

### DESCRIPTION OF EMBODIMENTS

Hereinafter, an operation control model is a representation of an operation and control abilities, properties and/or capabilities of the building of a kind that allows to directly generate (ex. compile) operation control command sequences (programs, codes, et cetera.)

### First Embodiment

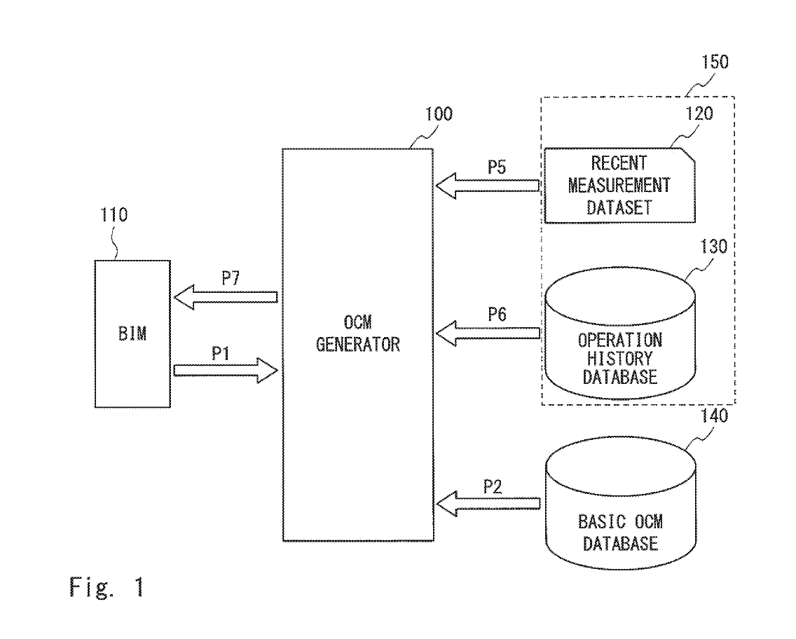

An operation control model (OCM) generator according to a first embodiment will be described. FIG. 1 is a block diagram schematically illustrating a configuration of an operation control model (OCM) generator 100 and peripheral configurations of the OCM according to the first embodiment. The building control system 1000 includes the OCM generator 100, a building information model (BIM) 110, a recent measurement dataset 120, an operation history database 130, and a basic operation control model (OCM) database 140.

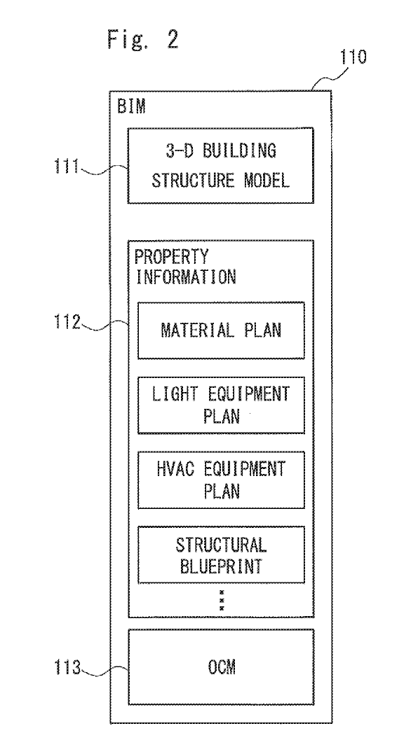

FIG. 2 is a block diagram schematically illustrating a configuration of the BIM 110. The BIM 110 may include a 3-D building structure model 111, property information 112, and an operation control model (OCM) 113. The BIM 110 is data for constructing, managing, and maintaining the building. Specifically, the BIM 110 can be useful for a building program, a conceptual design, a detailed design, analysis, documentation, fabrication (fabrication of construction materials), construction (4-D (3-D and time) or 5-D (3-D, time and cost)), construction logistics, operation and maintenance, and renovation or demolition of the building. The BIM 110 can be provided as a program for controlling the operation of the building or the data as the data referred from an operation control program according to the present invention described below. In this case, the BIM 110 can be stored in any memory device. Note that the 3-D building structure model 111 and the property information 112 are generally included in a general BIM.

The 3-D building structure model 111 is data representing a 3-D physical structure of the building. For example, the 3-D building structure model 111 can represent a shape of the building, arrangements of posts, beams, floors, walls, ductwork, et cetera. A plane view, a cross-sectional view, and a perspective view can be acquired by converting the 3-D building structure model 111 as appropriate.

The property information 112 is data representing properties of the structure elements (e.g., the posts, beams, floors, walls, et cetera.). The above-mentioned 3-D building structure model 111 provides only a physical structure of the building and the structure elements using lines, dots, planes (e.g., 3-D CAD data), et cetera, so that the property of the structure element cannot be recognized from the 3-D building structure model 111 itself. Thus, the property information 112 specifies the property of each structure element. In sum, the building control system including the BIM 110 can recognize the property of each structure element with reference to the property information 112. For example, as shown in FIG. 2, the property information 112 may include a material plan, a light equipment plan, an HVAC equipment plan, and a structural blueprint.

The OCM 113 is data for effectively controlling an operation of the building. The OCM 113 can be configured as data or a computer program capable of controlling the building operation using some relevant parameters, mathematical expressions, mathematical models, et cetera, for example, as in the case of the above-description of the BIM 110. For example, the OCM 113 is configured by using state diagrams, differential equations, or a Unified Modeling Language (UML), or combinations of two or all thereof. Further, the OCM 113 can be used for various operation controls. For example, the OCM 113 can be used for achieving at least one of an optimal scheduling of the operation control, an optimal controlling of the target building, a demand response negotiation, an energy prediction, a comfort prediction.

The recent measurement dataset 120 includes information of the resent condition (e.g., temperature, humidity, a status of air conditioning, et cetera.) of the building that is a target of the operation control (also as referred to a target building). The operation history database 130 includes information of the building operation (or the building condition) history of the target building.

The basic OCM database 140 includes basic models for operation control that correspond to primitives described below in detail. Hereinafter, the primitive means minimum data unit to describe a structural (functional, operational) unit of the building, so that primitive cannot be divided into further smaller units (e.g., sub-primitives) or a further subdivision does not lead to any advantage. The primitive can be re-usable and re-used in the application of the OCM generator 100.

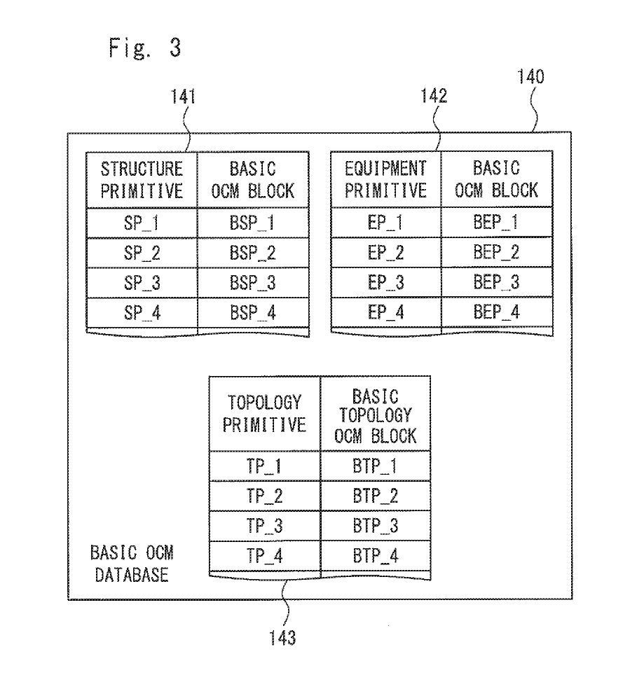

The basic models in the basic OCM database 140 can be acquired from a computer simulation or experiences of other actual buildings. FIG. 3 is a block diagram schematically illustrating the basic models included in the basic OCM database 140. In this embodiment, as shown in FIG. 3, the basic OCM database 140 includes an equipment structure primitive 141 corresponding to the structure primitives, a second table 142 corresponding to the equipment primitives, and a basic topology OCM block 143 corresponding to the topology primitives. Each of the equipment structure primitive 141, the second table 142, and the basic topology OCM block 143 includes basic models corresponding to the primitives described above. In FIG. 3, the structure primitives are referred as SP_i (i is an integer equal to or more than one) and the basic OCM blocks (i.e., the basic models) corresponding thereto are referred as BSP_i. The building equipment primitives are referred as EP_j (j is an integer equal to or more than one) and the basic OCM blocks (i.e., the basic models) corresponding thereto are referred as BEP_j. The topology primitives are referred as TP_k (k is an integer equal to or more than one) and the basic topology primitives (i.e., the basic models) corresponding thereto are referred as BTP_k. Note that the basic OCM database 140 is provided in advance before the COM 113 is generated.

The building OCM generator 100 refers to the recent measurement dataset 120, the operation history database 130, and the basic OCM database 140 to generate the OCM for controlling the building and provides the BIM 110 with the generated OCM. As a result, the generated OCM is incorporated in the BIM 110 as the OCM 113.

The BIM 110, the recent measurement dataset 120, the operation history database 130, and the basic OCM database 140 may be stored in a common storage device or may be individually or partially separately stored in two or more storages. In other words, storing the BIM 110, the recent measurement dataset 120, the operation history database 130, and the basic OCM database 140 is not limited to a specific configuration or method. Hereinafter, the recent measurement dataset 120 and the operation history database 130 are collectively referred to as building condition information 150.

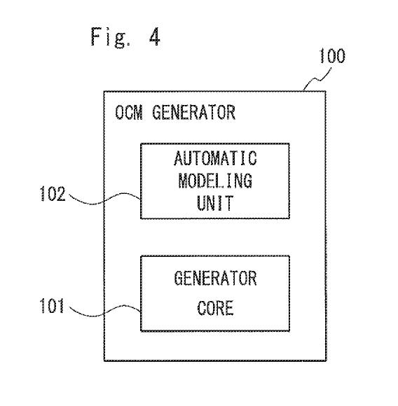

FIG. 4 is a block diagram schematically illustrating a configuration of the OCM generator 100. The OCM generator 100 includes a generator core 101 and an automatic modeling unit 102. Hereinafter, the automatic modeling unit 102 can be merely referred to as a modeling unit.

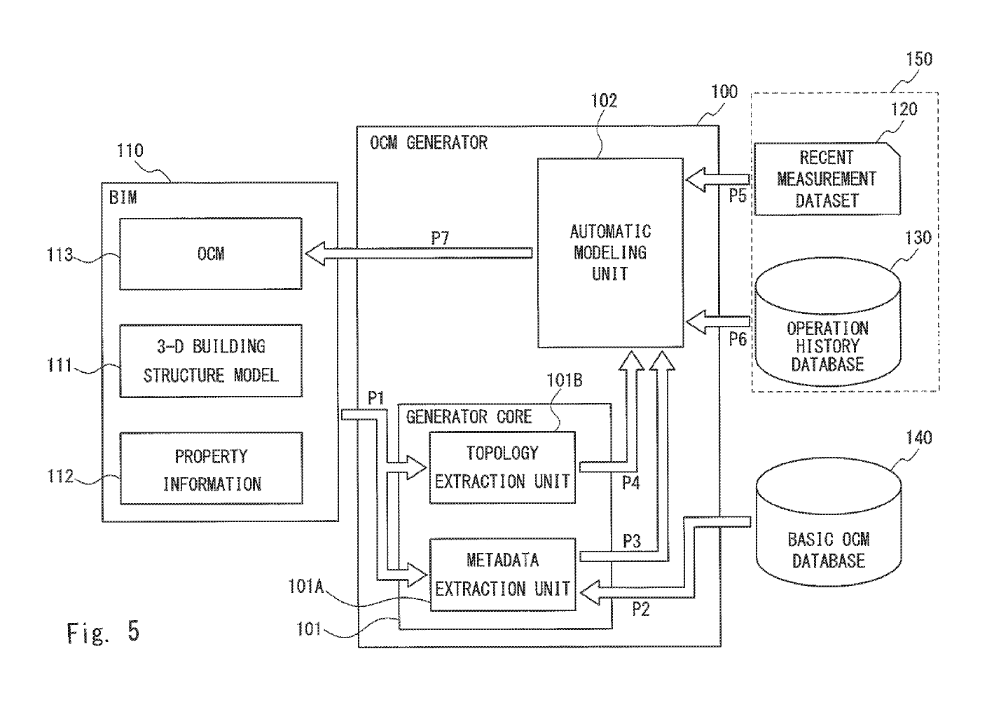

Here, a detailed configuration and operation of the OCM generator 100 will be described. FIG. 5 is a block diagram schematically illustrating a detailed configuration of an operation control model (OCM) generator 100 and peripheral configurations of the OCM. The generator core 101 includes a metadata extraction unit 101A and a topology extraction unit 101B.

The metadata extraction unit 101A reads metadata from one or both of the 3-D building structure model 111 and the property information 112 in the BIM 110 as appropriate (a path P1 in FIGS. 1 and 5) and extracts the read metadata to acquire primitives. Here, the primitive represents the simplest unit object. In the present embodiment, the metadata extraction unit 101A acquires the structure primitives, the equipment primitives, and the topology primitives. The structure primitive represents the simplest solid unit information such as a meeting room, an office room, an elevator hall, an entrance hall, a collection of at least one thermal zone, or a combination of rooms or halls when they cannot be separated for some reasons. The equipment primitive represents the simplest device unit information such as an air conditioning unit, a lighting unit, an elevator, an escalator, and a plumbing installation. The topology primitive represents the simplest connection and arrangement of the structure primitives or the equipment primitives, the smallest floor plan (an arrangement of the rooms and halls), or the arrangement of the floors. In other words, part of the building information (BIM) can be converted into a collection of the primitives of different kinds. In this case, some primitives can include the same information, however, formats of those primitives are different from each other. It should be appreciated that the configuration and property of the building are represented by integration of the building, equipment, and topology primitives.

Then, the metadata extraction unit 101A refers to the basic OCM database 140 to compare each acquired primitive with the corresponding basic models in the basic OCM database 140 (a path P2 in FIGS. 1 and 5). In sum, the metadata extraction unit 101A compares the structure, equipment, and topology primitives with the equipment structure primitive 141, the second table 142, and the basic topology OCM block 143, respectively. Then, the metadata extraction unit 101A selects the basic models (the basic OCM blocks or the basic topology primitives) which are the same as or the most similar to the acquired primitives and are incorporated with the OCM. After that, the metadata extraction unit 101A sends out the selected basic models (the selected basic OCM blocks and the selected basic topology primitives) to the automatic modeling unit 102 (a path P3 in FIGS. 1 and 5).

The topology extraction unit 101B reads the metadata from one or both of the 3-D building structure model 111 and the property information 112 in the BIM 110 as appropriate (the path P1 in FIGS. 1 and 5) and extracts the read metadata to acquire the overall topology information. Here, the overall topology information defines a relationship among all the primitives acquired in the metadata extraction unit 101A. Then, the topology extraction unit 101B sends out the overall topology information to the automatic modeling unit 102 (a path P4 in FIGS. 1 and 5).

Here, the automatic modeling unit 102 will be described. The automatic modeling unit 102 generates the OCM and sends back the generated OCM to the BIM 110 (a path P7 in FIGS. 1 and 5). Specifically, the automatic modeling unit 102 receives the above-mentioned selected basic models (the selected basic OCM blocks and the selected basic topology primitives) and the overall topology information, and integrates the basic models (the selected basic OCM blocks and the selected basic topology primitives) into the OCM using the overall topology information.

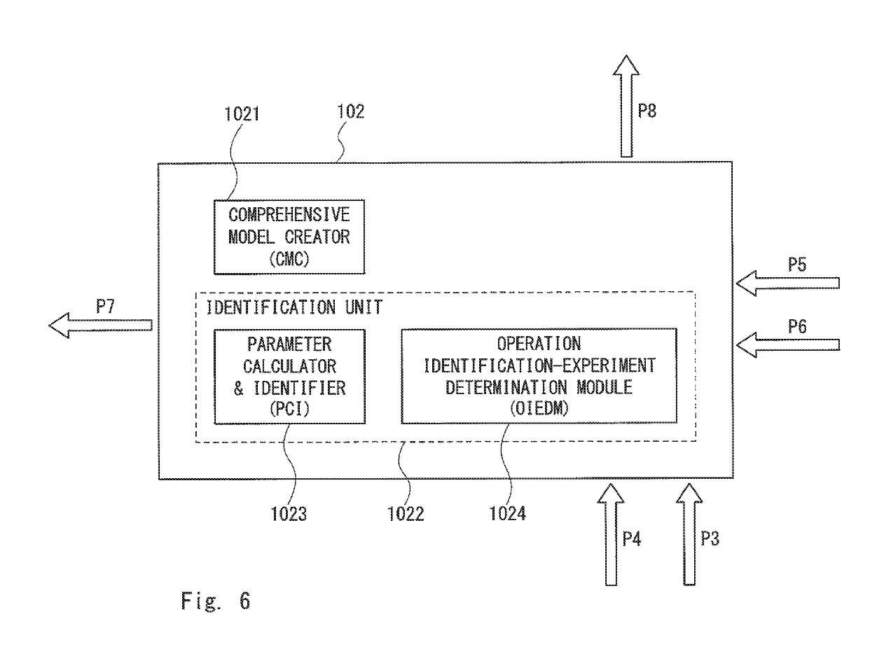

FIG. 6 is a block diagram schematically illustrating a configuration of the automatic modeling unit 102. As shown in FIG. 6, the automatic modeling unit includes a comprehensive model creator (also referred to as CMC) 1021 and an identification unit 1022. The identification unit 1022 includes a parameter calculator and identifier (also referred to as PCI) 1023, and an operation identification-experiment determination module (also referred to as OIEDM) 1024.

The CMC 1021 receives the topology information (FT1, or the P4 in FIGS. 1 and 5) and the collection of basic OCM blocks (the path P3 in FIGS. 1 and 5) regarding topology, equipment and (equipment) structure. Then, the CMC 1021 generates a comprehensive model, which is the OCM itself (the path P7 in FIGS. 1 and 5), consisting of a hybrid system model (in the sense of combined event-driven, state-diagram based and—in the general case nonlinear—continuous or discrete time system) with operational constraints (equalities and inequalities).

The CMC 1021 may have some specific functionalities such as model unification, parameter mapping, and Constraint determination, for example. The model unification is achieved by reducing cross dependencies and resolving parallel, series, feed-back connections of the basic OCM blocks in order to create a compact representation of the OCM. In the parameter mapping, the parameters of the basic OCM blocks are mapped to the final parameter of the OCM. In the constraint determination, equipment constraints are mapped to the constraints of the final model.

Note that the automatic modeling unit 102 may refer to one or both of the recent measurement dataset 120 and the operation history database 130 to adjust parameters in the selected basic models of the OCM (paths P5 and P6 in FIGS. 1 and 5). Note that the parameters define a function of the basic model. In this case, it can be understood that the OCM suitable for precise operation control can be generated and the operation control can adapt to the operation environment change. Further, the automatic modeling unit 102 may use prediction (values) of the building condition (not illustrated in the drawings). In this case, the OCM can correspond to condition variation included by the prediction of the building condition which is derived from weather prediction provided from public agencies, et cetera. Note that the prediction of the building condition is also included in the building condition information 150.

Specifically, the PCI 1023 identifies the parameters, and the OIEDM 1024 determines identification condition and associated need for further experimental necessary to improve the identification condition using a result of the parameter identification. If the parameter identification conditions are poor, the OIEDM 1024 automatically generates an appropriate operation identification-experiment (a path P8 in FIGS. 5 and 6). Under the operation identification-experiment, it is understood a schedule for the building actuators chosen in a way that identification conditions are particularly beneficial for the calculation of the OCM parameters or a subset of the OCM parameters.

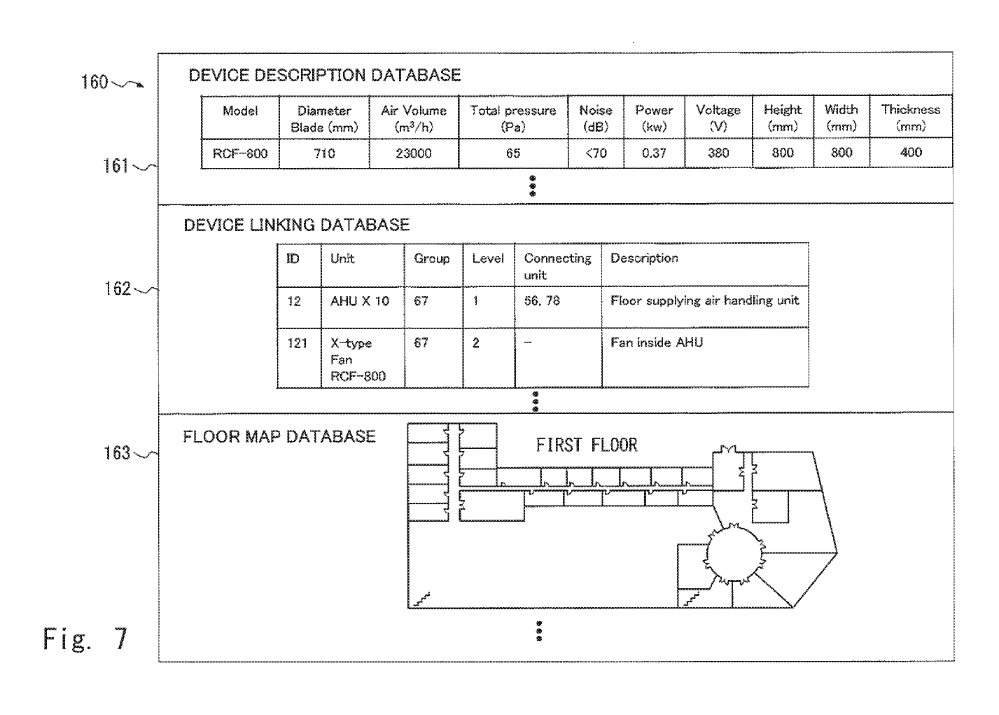

Further, a particular example will be described. FIG. 7 is a diagram illustrating a configuration of a BIM 160 of the particular example. The BIM 160 includes a device description database 161, a device linking database 162, and a floor map database 163.

The device description database 161 includes data defining properties of the devices disposed in the target building. In this case, the device description database 161 includes the data defining a fan unit device “RCF-800”, et cetera, for example.

The device linking database 162 includes data defining linkage of the devices disposed in the target building. In this case, the device description database 161 includes the data defining the linkage information of an air handling unit “AHU XY 10”, an X-type fan “RCF-800” that is described in the explanation of the device description database 161 and included in the “AHU XY 10”, et cetera, for example.

The floor map database 163 includes data defining designs of each floor of the target building. In this case, the floor map database 163 includes the floor plans of a first floor and other floors, for example.

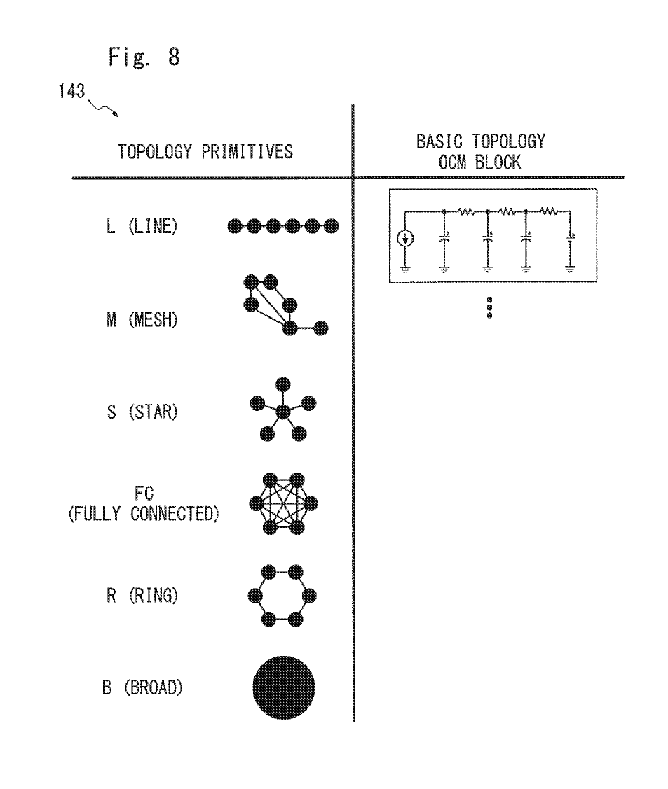

FIG. 8 is a diagram illustrating a particular configuration of the basic topology OCM block 143 of the particular example. The basic topology OCM block 143 includes particular topology primitives such as a primitive for a line topology L, a primitive for a mesh topology M, a primitive for star topology S, a primitive for fully connected topology FC, a primitive for ring topology R, and a primitive for broad topology B, for example. Then, the basic topology OCM block 143 also includes electro-thermal models represented by arrangement of capacitors and resistors as the basic topology OCM blocks corresponding to the above-mentioned six particular primitives (L, M, S, FC, R, and B).

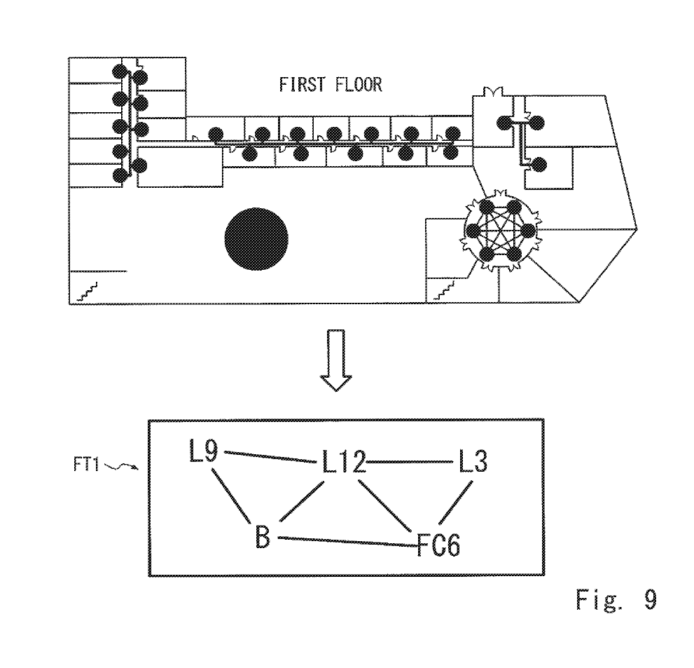

In this example, the topology extraction unit 101B derives the overall topology information P4 from the floor map database 163. FIG. 9 is a diagram illustrating a configuration of a part of the overall topology information. As shown FIG. 9, the floor plan of the first floor includes line topologies, a fully connected topology, and a broad topology. Thus, the topology extraction unit 101B acquires the first floor topology FT1 represented by the particular topology primitives in the basic topology OCM block 143. In this case, the numerals of L9, L12, L3, and FC6 represent the number of the nodes (or devices) constituting each structure.

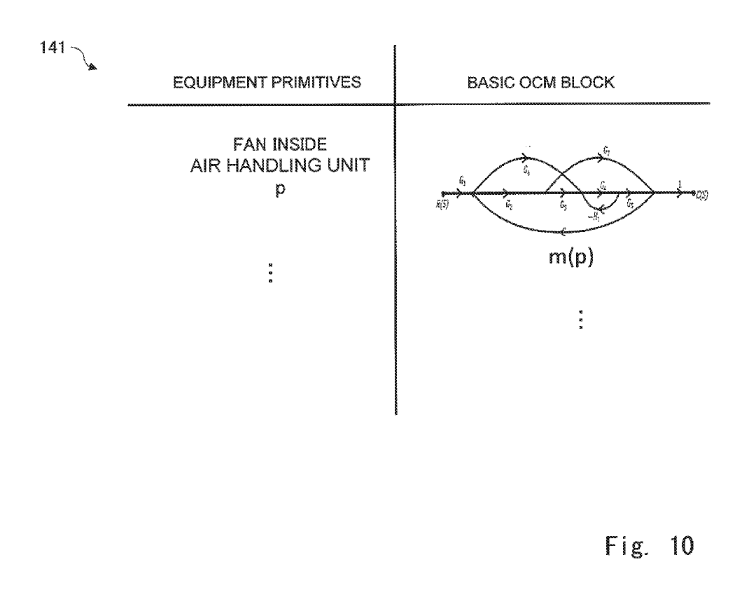

Next, a particular example of the equipment structure primitive 141 will be described. FIG. 10 is a diagram illustrating the particular example of the equipment structure primitive 141. As shown in FIG. 10, the equipment structure primitive 141 includes a primitive for X-type fan RCF-800, et cetera, as the equipment primitives. Then, the equipment structure primitive 141 also includes signal flow diagram type descriptions parameterized by mappings of parameters as the basic OCM blocks. In this case, the equipment structure primitive 141 includes a signal flow diagram type description 141A parameterized by the mapping of parameters m(p). For example, the parameters p for “RCF-800” consist of the properties of “RCF-800” included in the device description database 161 (A diameter blade, air volume, total pressure, noise, power, voltage, height, width, thickness in FIG. 7) which are mapped to model parameters m(p) by the mapping m(.).

The metadata extraction unit 101A refers to the equipment structure primitive 141 to compare each acquired primitive from the device description database 161 and the device linking database 162 (the paths P1 and P2). Then, the metadata extraction unit 101A sends out the acquired basic OCM block (the signal flow diagram type description 141A) and parameters thereof to the automatic modeling unit 102 (the paths P3). The automatic modeling unit 102 can control the function of the acquired basic OCM block by adjusting the parameters of m(p).

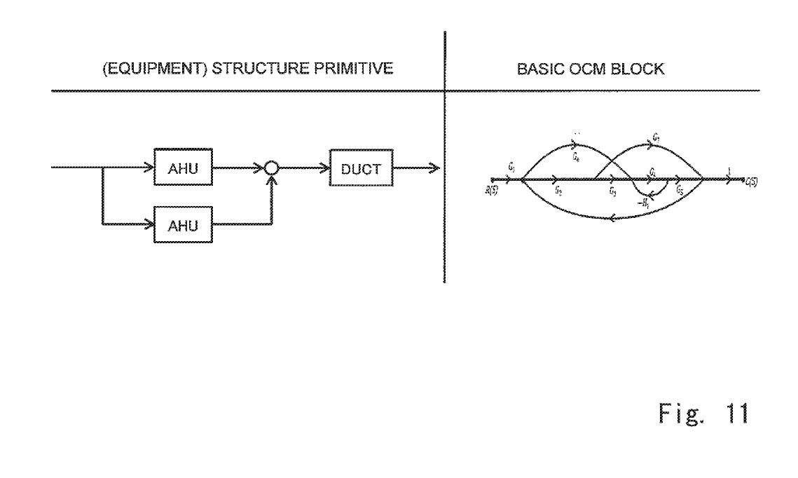

Further, the metadata extraction unit 101A refers to the equipment structure primitive 141 to compare each acquired primitive from the device description database 161 and the device linking database 162 (the paths P1 and P2). The metadata extraction unit 101A sends out the acquired basic OCM block to the automatic modeling unit 102 (the path P3). FIG. 11 is a diagram illustrating a particular example of the configuration of the acquired basic OCM model of the structure. As shown in FIG. 11, the acquired basic OCM model of the structure is represented by a functional diagram. In this example, input air flows are supplied to two air handling units (AHUs), and output air flows are integrated. The integrated air flows are pass through a duct DUCT. Further, the OCM sent to the BIM consists of non-linear dynamic models including differential equations, constraint (in) equalities, etc., for example.

As described above, according to the present embodiment, it is possible to be understood that the OCM generator can specifically generate the OCM, which is generated using the information of the building structure included in the BIM, for desirably controlling the building. In sum, the desirable OCM is easily and automatically generated without any cut-and-try method.

Further, the automatic modeling unit 102 can keep the generated OCM up to date and continually refer to the building condition information (the recent measurement dataset 120, the operation history database 130, and the building condition information). In this case, when the building condition information is changed (i.e., updated), the automatic modeling unit 102 can adjust the parameters in the kept OCM and update the OCM 113 by sending out the adjusted OCM to the BIM110. Therefore, the automatic modeling unit 102 can constantly adjust the OCM 113 so that it is advantageous for optimally controlling the operation of the building.

### Other Embodiment

Note that the present invention is not limited to the above exemplary embodiments and can be modified as appropriate without departing from the scope of the invention. For example, an example where the building condition information includes the recent measurement dataset 120, the operation history database 130, and the building condition information, however, it is merely an example. Thus, the building condition information may include other information or data.

The configuration of the BIM 110 is merely an example. Therefore it should be appreciated that the BIM 110 can include other data. Further, the configuration of the generator core 101 is merely an example. For example, although the metadata extraction unit 101A and the topology extraction unit 101B are configured to be separated each other in the generation core 101 in the above-description, the metadata extraction unit 101A and the topology extraction unit 101B may be configured as a single unit.

In the above exemplary embodiments, the present invention is described as a software configuration, but the present invention is not limited to this. According to the present invention, any processing can be implemented by causing a CPU (Central Processing Unit) to execute a computer program. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

While the present invention has been described above with reference to exemplary embodiments, the present invention is not limited to the above exemplary embodiments. The configuration and details of the present invention can be modified in various ways which can be understood by those skilled in the art within the scope of the invention.

### REFERENCE SIGNS LIST

100 OPERATION CONTROL MODEL (OCM) GENERATOR
101 GENERATOR CORE
102 AUTOMATIC MODELING UNIT
101A METADATA EXTRACTION UNIT
101B TOPOLOGY EXTRACTION UNIT
110, 160 BUILDING INFORMATION MODEL (BIM)
111 3-D BUILDING STRUCTURE MODEL
112 PROPERTY INFORMATION
113 OPERATION CONTROL MODEL (OCM)
120 RECENT MEASUREMENT DATASET
130 OPERATION HISTORY DATABASE
140 BASIC OPERATION CONTROL MODEL (OCM) DATABASE
141 EQUIPMENT STRUCTURE PRIMITIVE
142 SECOND TABLE
143 BASIC TOPOLOGY OCM BLOCK
150 BUILDING CONDITION INFORMATION
161 DEVICE DESCRIPTION DATABASE
162 DEVICE LINKING DATABASE
163 FLOOR MAP DATABASE
1021 COMPREHENSIVE MODEL CREATOR
1022 IDENTIFICATION UNIT
1023 PARAMETER CALCULATOR AND IDENTIFIER
1024 OPERATION IDENTIFICATION-EXPERIMENT DETERMINATION MODULE

1. An operation control model generator comprising:
a generator core configured to read metadata representing a configuration of a building to acquire primitives of the building from a building information model, read basic models corresponding to the acquired primitives from a basic operation control model database, and send out the acquired basic models; and
a modeling unit configured to receive the acquired basic models from the generator core, adjust the acquired basic models based on building condition information, and convert the basic models into an operation control model.

2. The building operation control model generator according to claim 1, wherein
the modeling unit sends out the operation control model, and
the operation control model is incorporated with the building information model.

3. The operation control model generator according to claim 1, wherein
each basic model includes one or more parameters defining a function of the basic model, and
the modeling unit adjusts one or more parameters to adjust each basic model.

4. The operation control model generator according to claim 1, wherein
the generator core comprises:
a metadata extraction unit configured to read and extract the metadata to acquire the primitives, refer to the basic operation control model database to acquire the basic models corresponding to the acquired primitives, and send out the acquired basic models to the modeling unit; and
a topology extraction unit configured to read and extract the metadata to acquire overall topology information of the building, and send out the overall topology information to the modeling unit, and
the modeling unit combines the basic models using the overall topology information to generate the operation control models.

5. The operation control model generator according to claim 4, wherein
the metadata extraction unit:
compares the each primitive with the basic models in the basic operation control model database;
selects a corresponding basic model in response to a case that the corresponding basic model has the same configuration as the compared primitive; and
selects a basic model that is the most similar to the compared primitive as the corresponding basic model in response to a case that there is no basic model having the same configuration as the compared primitive.

6. The operation control model generator according to claim 1, wherein
the primitives include:
structure primitives representing structures of elemental units of the building;
equipment primitives representing equipment units disposed in the building; and
topology primitives representing spatial relationships of the structure primitives and the equipment primitives, and
the basic models include basic models corresponding to the structure primitives, the equipment primitives, and the topology primitives.

7. The operation control model generator according to claim 1, wherein the modeling unit updates the operation control model based on the building condition information that is received after the generation of the operation control model.

8. The operation control model generator according to claim 1, wherein the building condition information includes resent measurement data of the building condition, an operation history of the building, and a prediction of the building condition.

9. An operation control model generation method of a building comprising:
reading metadata representing a configuration of a building to acquire primitives of the building from a building information model, reading basic models corresponding to the acquired primitives from a basic operation control model database, and sending out the acquired basic models; and
receiving the acquired basic models, adjusting the acquired basic models based on building condition information, and converting the basic models into an operation control model.

10. A non-transitory computer readable medium storing an operation control model generation program for causing a computer to execute processing comprising:
causing an operation core to read metadata representing a configuration of a building to acquire primitives of the building from a building information model from a storage, to read basic models corresponding to the acquired primitives from a basic operation control model database from the storage, and to send out the acquired basic models; and
causing an modeling unit to receive the acquired basic models, to adjust the acquired basic models based on building condition information, and to convert the basic models into an operation control model.
